(19) United States
(12) Patent Application Publication
(10) Pub. No.: US 2017/0229706 A1
(43) Pub. Date: Aug. 10, 2017

(54) ELECTRODE FOR A BATTERY CELL AND BATTERY CELL

(71) Applicant: Robert Bosch GmbH, Stuttgart (DE)

(72) Inventors: Bernd Schumann, Rutesheim (DE); Pallavi Verma, Leinfelden (DE)

(21) Appl. No.: 15/514,566

(22) PCT Filed: Sep. 1, 2015
(86) PCT No.: PCT/EP2015/069923

§ 371 Date: Mar. 27, 2017

(30) Foreign Application Priority Data
Sep. 29, 2014 (DE) 102014219723.6

(51) Int. Cl. H01M 4/36; H01M 4/62; H01M 10/0525; H01M 4/38

(52) U.S. Cl. CPC H01M 4/366; H01M 4/386; H01M 4/622; H01M 4/624; H01M 10/0525; H01M 2220/20

(57) ABSTRACT

An electrode for a battery cell, including an active material that contains silicon, the active material having a coating that contains a polymer that is dendritic. A battery cell that includes at least one electrode is also provided.

### FIELD

The present invention relates to an electrode for a battery cell that includes an active material containing silicon. The present invention also relates to a battery cell that includes an electrode.

### BACKGROUND INFORMATION

Electrical energy can be stored by batteries. Batteries convert chemical reaction energy into electrical energy. A distinction is made between primary batteries and secondary batteries. Primary batteries can be used only once, while secondary batteries, also referred to as accumulators, can be recharged. A battery includes one or more battery cells.

In an accumulator, in particular so-called lithium-ion battery cells are used. These are distinguished by, inter alia, high energy densities, thermal stability, and extremely low self-discharge. Lithium-ion ion batteries are used in, inter alia, motor vehicles, in particular electric vehicles (EV), hybrid vehicles (hybrid electric vehicles, HEV), and plug-in hybrid vehicles (plug-in hybrid electric vehicles, PHEV).

Lithium-ion battery cells have a positive electrode, also referred to as the cathode, and a negative electrode, also referred to as the anode. The cathode and anode each have a current drain on which an active material is applied. The active material for the cathode is for example a metal oxide. The active material for the anode is for example graphite or silicon.

Lithium atoms are embedded in the active material of the anode. During operation of the battery cell, i.e., during a discharge process, electrons flow from the anode to the cathode in an external current circuit. Inside the battery cell, during a discharge process lithium ions migrate from the anode to the cathode. Here, the lithium ions are released from the active material of the anode in reversible fashion, which is also referred to as de-intercalation. During a charging process of the battery cell, the lithium ions migrate from the cathode to the anode. Here, the lithium ions again become embedded in the active material of the anode in reversible fashion, which is also referred to as intercalation.

The electrodes of the battery cell are made in the form of foils, and are wound to form an electrode coil with the interposition of a separator that separates the anode from the cathode. Such an electrode coil is also referred to as a jelly roll. The two electrodes of the electrode coil are connected electrically, via collectors, to poles of the battery cell, also referred to as terminals. As a rule, a battery cell includes one or more electrode units. The electrodes and the separator are surrounded by an electrolyte, which as a rule is liquid. The electrolyte is conductive for the lithium ions and enables the transport of the lithium ions between the electrodes.

In addition, the battery cell has a cell housing made for example of aluminum. As a rule, the cell housing is made in a prismatic, in particular cuboid, shape, and is made pressure-resistant. The terminals are situated outside the cell housing. After the connection of the electrodes to the terminals, the electrolyte is filled into the cell housing.

A battery cell of the type indicated, in which the active material of the anode includes silicon, is described, for example, in German Patent Application No. DE 10 2012 212 299 A1.

As the active material of the anode, silicon has a capacity for storing lithium ions that is comparatively greater than that of graphite. However, the silicon, as active material of the anode, is attacked by the liquid electrolyte, which deposits together with the contained lithium on the surface of the active material, where it forms a layer referred to as “solid electrolyte interphase” (SEI). Lithium deposited there is no longer available for the transport of lithium ions between the electrodes.

### SUMMARY

An electrode for a battery cell is provided. The electrode includes an active material that contains silicon. According to the present invention, the active material has a coating that contains a polymer that is dendritic. In particular, the coating is impermeable for an electrolyte of the battery cell.

The electrode according to the present invention is in particular an anode of a battery cell.

The active material can include pure silicon. However, it is also possible for the active material to include an alloy containing silicon. In particular, alloys of silicon with aluminum, magnesium, tin, iron, titanium, or copper are possible. A doping is also possible.

Preferably, the active material has cores that are sheathed by the coating. The cores are present for example as nanoparticles, or also having a diameter of a few micrometers.

Advantageously, the coating is ionically conductive, and is thus impermeable for lithium ions that migrate from the active material of the anode to the cathode, as well as in the opposite direction.

Advantageously, the coating is also at least slightly electrically conductive, and is thus permeable for electrons that flow from the active material to a current drain of the anode, as well as in the opposite direction.

According to an advantageous embodiment of the present invention, the coating of the active material contains polyethylene oxide (PEO), poly-3,4-ethylenedioxythiophene (PEDOT), polyaniline (PANI), or polypyrrole (PPy), or another conductive polymer.

According to an advantageous development of the present invention, the coating has functionalized end groups that can be wetted by an electrolyte of the battery cell.

A battery cell is also proposed that includes at least one electrode according to the present invention.

A battery according to the present invention is advantageously used in an electric vehicle (EV), a hybrid vehicle (HEV), or a plug-in hybrid vehicle (PHEV).

The coating, which is impermeable for the electrolyte, of the active material prevents contact between the electrolyte and silicon, and thus prevents depositing of the electrolyte on the surface of the active material. During operation of the battery cell, no formation of a solid electrolyte interphase (SEI) layer therefore takes place. Due to the silicon as active material, in comparison to graphite the electrode has an increased capacity for storing lithium ions. The coating, and thus also the active material, also has a high ionic conductivity for lithium ions, and a high electrical conductivity for electrons. Even when there is an expansion of the silicon during a depositing of lithium on the cores of the active material, the dendritic polymer remains as coating on the cores, and continues to form a barrier that is impermeable for the electrolyte.

If the dendritic polymer, which sheaths the cores of the anodic active material as a coating, has functionalized end groups that are functionalized in such a way that the end groups can be wetted with the electrolyte, then when the end groups are wetted with the electrolyte lithium ions are detached from the electrolyte. The mobility of the migrating lithium ions is improved by the detaching of the lithium ions from the electrolyte.

### BRIEF DESCRIPTION OF THE DRAWINGS

Specific embodiments of the present invention are explained in more detail on the basis of the figures and the following description.

FIG. 1 shows a schematic representation of a battery cell.

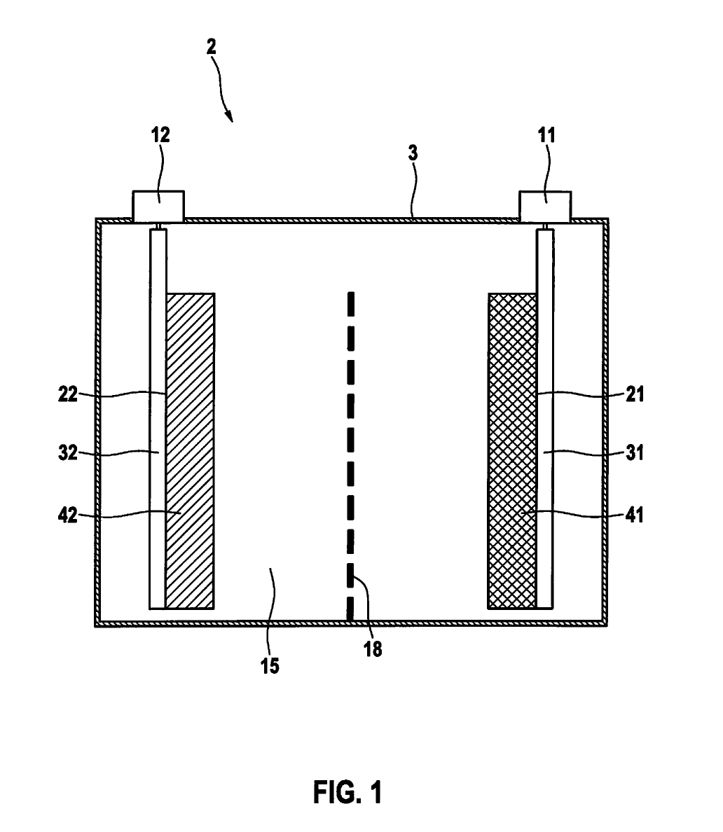

FIG. 2 shows a core of an anodic active material with coating.

### DETAILED DESCRIPTION OF EXAMPLE EMBODIMENTS

A battery cell 2 includes a cell housing 3 that is fashioned with a prismatic, in the present case cuboidal, shape. In the present case, cell housing 3 is made electrically conductive, and is made for example of aluminum. Battery cell 2 includes a negative terminal 11 and a positive terminal 12. A voltage provided by battery cell 2 can be picked off via terminals 11, 12. In addition, battery cell 2 can also be charged via terminals 11, 12. Terminals 11, 12 are situated at a distance from one another on a covering surface of prismatic cell housing 3.

Inside cell housing 3 of battery cell 2, there is situated an electrode coil that has two electrodes, namely an anode 21 and a cathode 22. Anode 21 and cathode 22 are each made as foils, and are wound to form the electrode coil with the interposition of a separator 18. It is also possible for a plurality of electrode coils to be provided in cell housing 3.

Anode 21 includes an anodic active material 41 fashioned as a foil. Anodic active material 41 has as base material silicon or an alloy containing silicon. Anode 21 further includes a current drain 31, also realized as a foil. Anodic active material 41 and current drain 31 are placed with their surfaces against one another and are connected to one another.

Current drain 31 of anode 21 is electrically conductive and is made of a metal, for example copper. Current drain 31 of anode 21 is electrically connected to negative terminal 11 of battery cell 2.

Cathode 22 includes a cathodic active material 42 realized as a foil. Cathodic active material 42 has as base material a metal oxide, for example lithium-cobalt oxide (LiCoO₂). Cathode 22 further includes a current drain 32, also realized as a foil. Cathodic active material 42 and current drain 32 are placed with their surfaces against one another and are connected to one another.

Current drain 32 of cathode 22 is made electrically conductive and is made of a metal, for example aluminum. Current drain 32 of cathode 22 is electrically connected to positive terminal 12 of battery cell 2.

Anode 21 and cathode 22 are separated from one another by separator 18. Separator 18 is also realized as a foil. Separator 18 is made electrically insulating, but ionically conductive, i.e. permeable for lithium ions.

Cell housing 3 of battery cell 2 is filled with a liquid electrolyte 15. Electrolyte 15 surrounds anode 21, cathode 22, and separator 18. Electrolyte 15 is also ionically conductive.

Anodic active material 41 has cores 50 of silicon, in the form of nanoparticles. Cores 50 can also be present in an enlarged form, and can have for example a diameter of a few micrometers.

Instead of, or in addition to, pure silicon, anodic active material 41 can also include an alloy containing silicon. This can be an alloy having an active metal, for example aluminum, magnesium, or tin, i.e., a metal that can accept lithium ions. However, an alloy having an inactive metal is also possible, for example having iron, titanium, or copper, i.e., a metal that cannot accept lithium ions.

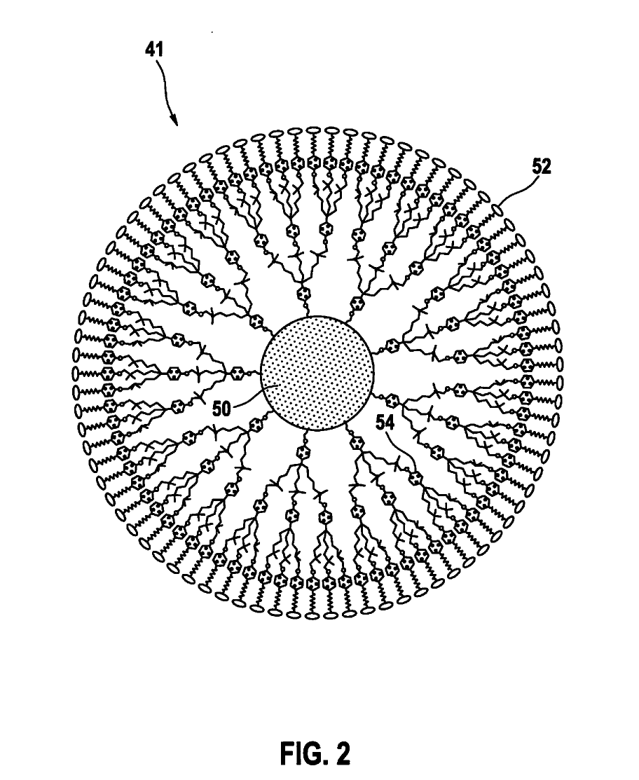

Anodic active material 41 has a coating 54. Coating 54 is applied onto cores 50, and cores 50 are sheathed by coating 54. Such a core 50 of an anodic active material 41 having such a coating 54 is shown schematically in FIG. 2. Coating 54 can take place for example by polymerization, grafting, gluing, immersion, or deposition.

Coating 54 contains a dendritic polymer, also referred to as a dendrimer. Coating 54 here is ionically conductive, i.e., permeable for lithium ions. Thus, lithium ions can migrate through coating 54. During a discharge process, lithium ions migrate from core 50 through coating 54 to cathode 22. During a charging process, lithium ions migrate from cathode 22 through coating 54 to core 50.

Coating 54 is also electrically conductive, i.e. permeable for electrons. Thus, electrons can migrate through coating 54. During a discharge process, electrons migrate from core 50 through coating 54 to current drain 31 of anode 21. During a charging process, electrons migrate from current drain 31 of anode 21 through coating 54 to core 50.

Polyethylene oxide (PEO) is an example of a possible material for coating 54. However, other electrically conductive materials, such as poly-3,4-ethylenedioxythiophene (PEDOT), polyaniline (PANI), or polypyrrole (PPy), are also possible.

However, coating 54 of core 50 is impermeable for electrolyte 15. Thus, electrolyte 15 cannot penetrate coating 54, and therefore cannot come into contact with core 50. Thus, no electrolyte 15 can deposit on the silicon, or the alloy containing silicon, of anodic active material 41. Coating 54 of core 50 thus acts as a barrier to electrolyte 15.

When lithium accretes on cores 50 of anodic active material 41, the silicon expands. Even when there is such an expansion of the silicon of anodic active material 41, the dendritic polymer remains as coating 54 on cores 50, and continues to form a barrier impermeable to electrolyte 15.

Also possible as material for coating 54 of anodic active material 41 are further polymers that are dendritic, in particular stellate, and that are impermeable to electrolyte 15 situated in cell housing 3 of battery cell 2.

The dendritic polymer, which as coating 54 sheathes cores 50 of anodic active material 41, has end groups 52 on each surface facing away from core 50. End groups 52 of coating 54 are functionalized in such a way that end groups 52 can be wetted by electrolyte 15.

The stated functionalization takes place for example through proton exchange. For example, end group 52 previously contains a carboxylic acid group (—COOH). Addition of lithium hydroxide (LiOH) then yields a lithium-functionalized end group (—COOLi) and water (H₂O). However, other chemical reactions are also possible.

When end groups 52 are wetted with electrolyte 15, lithium ions are detached from electrolyte 15. This improves the mobility of the migrating lithium ions.

The present invention is not limited to the exemplary embodiments described here or to the aspects emphasized therein. Rather, within the scope of the present invention, a large number of modifications are possible that are within the scope of practice of those skilled in the art.

1-10. (canceled).

11. An electrode for a battery cell, the electrode including an active material that contains silicon, wherein the active material has a coating that contains a polymer that is dendritic.

12. The electrode as recited in claim 11, wherein the electrode is an anode of a battery cell.

13. The electrode as recited in claim 11, wherein the active material has an alloy containing silicon.

14. The electrode as recited in claim 11, wherein the active material has cores that are sheathed by the coating.

15. The electrode as recited in claim 11, wherein the coating is ionically conductive.

16. The electrode as recited in claim 11, wherein the coating is electrically conductive.

17. The electrode as recited in claim 11, wherein the coating contains one of: polyethylene oxide (PEO), poly-3,4-ethylenedioxythiophene (PEDOT), polyaniline (PANI), or polypyrrole (PPy).

18. The electrode as recited in claim 11, wherein the coating has functionalized end groups that are capable of being wetted by an electrolyte.

19. A battery cell including at least one electrode, the electrode including an active material that contains silicon, wherein the active material has a coating that contains a polymer that is dendritic.

20. A method of using a battery cell, comprising:
providing a battery cell, the battery cell including at least one electrode, the electrode including an active material that contains silicon, wherein the active material has a coating that contains a polymer that is dendritic; and
using the battery cell in one of an electric vehicle, a hybrid vehicle, or a plug-in hybrid vehicle.
